(19) United States
(12) Patent Application Publication
(10) Pub. No.: US 2026/0203126 A1
(43) Pub. Date: Jul. 16, 2026

(54) SYSTEMS AND METHODS FOR CONTINUOUS BATCHING IN LARGE LANGUAGE MODEL INFERENCE

(71) Applicant: Huawei Technologies Co., Ltd., Shenzhen (CN)

(72) Inventors: Shi Chang, Kingston (CA); Haoxiang Zhang, Scarborough (CA); Boyuan Chen, Richmond Hill (CA); Ahmed E. Hassan, Kingston (CA)

(21) Appl. No.: 19/176,022

(22) Filed: Apr. 10, 2025

Related U.S. Application Data
(60) Provisional application No. 63/746,104, filed on Jan. 16, 2025.

(51) Int. Cl. G06F 9/50; G06F 9/54

(52) U.S. Cl. CPC G06F 9/5044; G06F 9/505; G06F 9/546; G06F 2209/548

(57) ABSTRACT

A process requirement aware (e.g., SLA aware) continuous batching framework aimed at ensuring high-priority tasks meet processing requirements. A continuous batching framework identifies requests whose processing requirements cannot be satisfied by the framework and prioritizes allocation of resources to requests whose processing requirements can be met. This feature, in combination with on-mode agents that individually assess the impact of processing a new request on active requests, aides in the compliance of processing requirements of requests as they are continuously added to the framework queue.

### CROSS-REFERENCE TO RELATED APPLICATIONS

The present application claims priority to US Provisional Ser. No. 63/746,104 filed Jan. 16, 2025, the contents of which are hereby incorporated by reference.

### TECHNICAL FIELD

The present application relates to large language model batch processing and, in particular, large language model continuous batch processing.

### BACKGROUND

Service level agreement-guarantee methods for batching deep neural network requests manage fixed-size batch processing, ensuring predictable resource allocation and latency compliance. With the rise in the use of large language models there is an increased demand for continuous batch processing, however, service level agreement-guarantee methods for continuous batching for large language models are much more complex.

### SUMMARY

In accordance with one aspect, the present application describes a computer-implemented method of receiving a plurality of requests, each request including a prompt for processing by a foundation model and an indication of one or more processing requirements associated with the request; using an estimation function, by a first on-mode agent of a plurality of on-mode agents, to determine that a first request of the plurality of requests in a queue can be processed by a first instance of the foundation model within constraints of the one or more processing requirements associated with the first request and without violating the one or more processing requirements associated with any of a plurality of requests currently being processed by the first instance of the foundation model, wherein each of the on-mode agents is associated with a respective instance of the foundation model; and in response to the determination using the estimation function, processing the first request by the first instance of the foundation model.

In some implementations, the method further includes training the estimation function including performing tests evaluating the performance of the foundation model when processing a various number of requests concurrently, wherein input variables to the tests include at least of one batch size, graphics processing unit (GPU) type, a foundation model type, and input length, for estimating generation speeds of the foundation model under different workload conditions. In some cases, the method further includes storing each of the plurality of requests in the queue and removing the first request from the queue.

In some implementations, the method further includes determining, by a queue manager, whether a required generation speed for processing a second request of the plurality of requests exceeds a maximum processing capability of any respective instances of the foundation model associated with the on-mode agents, and if so, flagging the second request as noncompliant.

In some implementations, the method further includes, based on the second request being flagged as noncompliant, processing the second request by a foundation model instance associated with an off-mode agent and removing the second request from the queue.

In some implementations, the foundation model instance associated with the off-mode agent is implemented on a remote server and the method further includes transmitting the second request by the queue manager to the remote server for processing by the foundation model instance associated with the off-mode agent.

In some implementations, the second request includes an indication of a maximum number of tokens expected to be generated by the foundation model and an indication of a request deadline indicating a desired completion time of processing the second request by the foundation model. In some cases, determining a required generation includes determining a ratio of a maximum number of tokens expected to be generated by the foundation model and, a time difference between the request deadline and a current time.

In some implementations, the method further includes, dependent on current processing capacity of a plurality of foundation model instances, identifying, by the queue manager, a third request of the plurality of requests as a low-priority request, and transmitting by the queue manager, the third request to a remote server via a communication network for processing by a foundation model instance associated with a remote agent.

In another aspect, the present application describes a system that may include one or more processors and memory, the memory storing processor-executable instructions that, when executed by the one or more processors, are to cause the one or more processors to receive a plurality of requests, each request including a prompt for processing by a foundation model and an indication of one or more processing requirements associated with the request; use an estimation function, by a first on-mode agent of a plurality of on-mode agents, to determine that a first request of the plurality of requests in a queue can be processed by a first instance of the foundation model within constraints of the one or more processing requirements associated with the first request and without violating the one or more processing requirements associated with any of a plurality of requests currently being processed by the first instance of the foundation model, wherein each of the on-mode agents is associated with a respective instance of the foundation model; and in response to the determination using the estimation function, process the first request by the first instance of the foundation model.

In another aspect, the present application describes a non-transitory, computer-readable medium storing computer-executable instructions that, when executed by one or more processors, are to cause the one or more processors to receive a plurality of requests, each request including a prompt for processing by a foundation model and an indication of one or more processing requirements associated with the request; use an estimation function, by a first on-mode agent of a plurality of on-mode agents, to determine that a first request of the plurality of requests in a queue can be processed by a first instance of the foundation model within constraints of the one or more processing requirements associated with the first request and without violating the one or more processing requirements associated with any of a plurality of requests currently being processed by the first instance of the foundation model, wherein each of the on-mode agents is associated with a respective instance of the foundation model; and in response to the determination using the estimation function, process the first request by the first instance of the foundation model.

In another aspect, the present application describes a computing system including one or more processors and a memory, the memory storing computer-executable instructions that, when executed by the one or more processors are to cause the one or more processors to carry out operations of one or more of the methods described herein.

In another aspect, the present application describes a computer program comprising instructions which, when executed by a computer, cause the computer to carry out operations of one or more of the methods described herein.

Other aspects and features of the present application will be understood by those of ordinary skill in the art from a review of the following description of examples in conjunction with the accompanying figures.

### BRIEF DESCRIPTION OF THE DRAWINGS

Embodiments of the invention are now described by way of non-limiting example and are illustrated in the following figures in which like reference numbers are used in the figures to indicate like elements and features. and wherein:

FIG. 1A shows a simplified block diagram of an exemplary computer system;

FIG. 1B shows a simplified block diagram of an exemplary network configuration with which some embodiments may operate;

FIG. 1C shows a simplified organization of software components stored in a memory of the example computer system;

FIG. 2 shows a simplified block diagram of an exemplary continuous batching framework;

FIG. 3 illustrates a simplified flowchart of an exemplary method of processing requests for large language model (LLM) generation;

FIG. 4 shows is a simplified flowchart of a method of generating an estimation function prior to runtime;

FIG. 5 shows a simplified flowchart of an exemplary method of evaluating whether processing a request by any one of the FM inferences associated with on-mode agents exceeds the capacity of any one of the FM inferences; and

FIG. 6 illustrates a simplified flowchart of another exemplary method of processing requests for large language model (LLM) generation.

### DETAILED DESCRIPTION OF ILLUSTRATIVE EMBODIMENTS

A service level agreement is a formalized commitment or contract between a service provider and a customer that specifies the expected level of service, including, but not limited to, performance metrics such as availability, latency, and response time. Service level agreement (SLA)-guarantee algorithms for static batching are widely used in existing inference frameworks to manage computational resources and meet strict latency requirements. These algorithms rely on fixed batch sizes, where requests are grouped based on their resource demands and task deadlines, such as tail-latency (i.e., processing time of a single request) SLAs. Once a batch is formed, the scheduler assigns it to a specific computational resource, such as a GPU, for execution. In static batching all requests within the batch must wait until every task in the batch is completed before results are returned. For example, a system might wait for three requests to arrive, group them into a batch, and send the batch to a GPU for processing. After completing the current batch, the next group of three requests is processed in the same way.

Fixed-size batch processing is unsuitable for processing by increasingly popular foundation models, wherein each request may require different execution times. Limitations of static batching include the inability to handle dynamic batch sizes wherein requests arrive asynchronously and may join or leave processing queues at any moment. This lack of flexibility results in processing inefficiencies and delays of requests. Additionally, variable resource competition further compounds the limitations of static batching. Inference tasks rely not only on GPU memory but also on GPU compute units. When requests flow in and out of the processing pipeline dynamically, resources are unevenly allocated, slowing down overall processing speeds and leading to resource underutilization. Another significant limitation arises from the inaccurate time estimation inherent in static batching. The auto-regressive structure of foundation models involves varying numbers of inference steps (tokens) for different requests. Static algorithms, designed for fixed batch sizes, are unable to predict request completion times accurately or adjust resource allocation dynamically. As a result, static batching suffers from high latency and reduced system throughput in dynamic environments.

Static batching follows a deterministic scheduling approach, ensuring predictable resource allocation for each request. Many established frameworks, including Llama® framework owned by Meta platforms Inc. and/or Clockwork®, implement this static batching mechanism to ensure that requests receive appropriate resources and are completed within the specified SLA deadlines, (i.e., processing requirements are met).

Unlike static batching, continuous batching allows requests to join and leave the execution process dynamically, following a First-Come-First-Serve (FIFO) approach which may significantly reduces waiting times and improves both throughput and latency. By dynamically adjusting batch sizes at runtime, continuous batching eliminates inefficiencies, enabling more responsive and scalable systems.

Industry evolution toward continuous batching and the rise of large language models (LLMs) present new challenges that static batching algorithms cannot address. It would be advantageous to provide a continuous batching method that addresses the challenges of meeting processing requirements of requests by large language models.

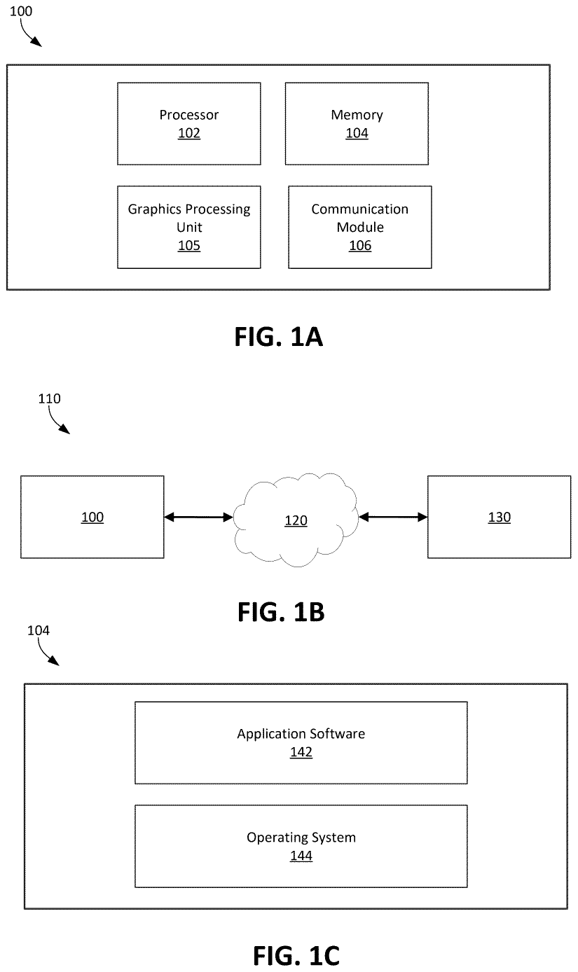

FIG. 1A shows a simplified block diagram of an exemplary computer system 100 comprising a processor 102, memory 104, graphics processing unit (GPU) 105, and communication module 106. For example, processor 102, memory 104, GPU 105 and communication module 106 may be communicatively coupled by a system communication bus, a wired network, a wireless network, or other connection mechanism and arranged to carry out various operations described herein. Optionally, two or more of these components may be integrated together in whole or in part.

Processor 102 may include one or more processors and/or controllers, which may take the form of a general or a special purpose processor or controller. In exemplary implementations, processor 102 may be, or include, microprocessors, microcontrollers, application specific integrated circuits, digital signal processors, and/or other data processing devices. Processor 102 may be a single device or distributed over a network.

Processor 102 may be configured to store, access, and execute computer-readable program instructions stored in memory 104, and to perform, for example, the operations described herein. Optional functions performed by the processor are described below.

Memory 104 may be or include one or more non-transitory computer-readable storage media, such as optical, magnetic, organic, or flash memory, among other data storage devices and may take any form of computer readable storage media. Memory 104 may be a single device or may be distributed over a network.

GPU 105 may include one or more GPUs and may be configured to store, access, and execute computer-readable program instructions stored in memory 104, and/or integrated memory, and to perform, for example, the operations described herein. Optional functions performed by the GPU are described below.

Communications module 106 allows the example computer system 100 to communicate with other computing systems, servers, and/or various communications networks. For example, the communications module 106 may allow the example computer system 100 to send or receive communications signals. As an example, the communication module 106 may include a network connection, data port, or the like. Communications signals may be sent or received according to one or more protocols or according to one or more standards. For example, the communications module 106 may allow the example computer system 100 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE), 5G, 6G, or the like. Additionally, or alternatively, the communications module 106 may allow the example computer system 100 to communicate using near-field communication (NFC), via Wi-Fi™, via the Ethernet family of network protocols, using Bluetooth™ or via some combination of one or more networks or protocols. In some embodiments, all or a portion of the communications module 106 may be integrated into a component of the example computer system 100. In some examples, the communications module may be integrated into a communications chipset.

Software instructions are executed by the processor 102 from a computer-readable medium. For example, software may be loaded into random-access memory from persistent storage within memory 104. Additionally, or alternatively, instructions may be executed by the processor 102 directly from read-only memory of the memory 104.

Software instructions are executed by the GPU 105 from a computer-readable medium. For example, software may be loaded into random-access memory from persistent storage within memory 104, and/or integrated memory. Additionally, or alternatively, instructions may be executed by the GPU 105 directly from read-only memory of the memory 104, and/or integrated memory.

Memory 104 allows data to be stored and retrieved. The memory 104 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computer system 100.

Now referring to FIG. 1B, shown is a simplified block diagram of an exemplary network configuration 110 with which some embodiments may operate. Network configuration 110 includes computer system 100, remote computer system 130 and communication network 120. Computer system 100 may be communicatively coupled to communication network 120 via communications module 106, enabling communication between computer system 100 and communication network 120, as well as enabling communication between computer system 100 and remote computer system 130. Computer system 100 may communicate with another communication network and/or a plurality of servers, memorys, and/or other devices, configured in a centralized, distributed or other arrangement.

Communication network 120 may include one or more computer systems and may be any suitable combination of networks or portions thereof to facilitate communication between network components. Some examples of networks include, cellular data networks, such as for example, according to one or more standards such as, for example, Global System for Mobile Communications (GSM), Universal Mobile Telecommunications Service (UMTS), General Packet Radio Service (GPRS), Code Division Multiple Access (CDMA), Evolution Data Optimized (EVDO), Enhanced Data Rates for GSM Evolution (EDGE), Long-term Evolution (LTE), 5G, 6G, or the like. Communication network 120 may operate according to one or more other communication protocols, such as LPWAN, Wi-Fi, Bluetooth, Ethernet, HTTP/S, TCP, and CoAP/DTLS, or other suitable protocol. Communication network 120 may include Wide Area Networks (WANs), Local Area Networks (LANs), Wireless Wide Area Networks (WWANs), data networks, voice networks, among other networks, which may be wired and/or wireless. Communication network 120 may take other forms as well.

FIG. 1C shows a simplified organization of software components stored in memory 104 of the example computer system 100. As illustrated, these software components include, at least, application software 142 and an operating system 144.

The application software 142 adapts the example computer system 100, in combination with the operating system 144, to operate as a system performing a particular function. While a single application software 142 is illustrated in FIG. 1C, in operation, the memory 104 may include more than one application software and different application software may perform different operations.

The operating system 144 is software. The operating system 144 allows the application software 142 to access processor 102, memory 104, GPU 105, and communications module 106.

The application software 142 and/or operating system 144 may, when executed, cause the processor 102 to carry out operations to implement at least some portion of one or more of the methods described herein.

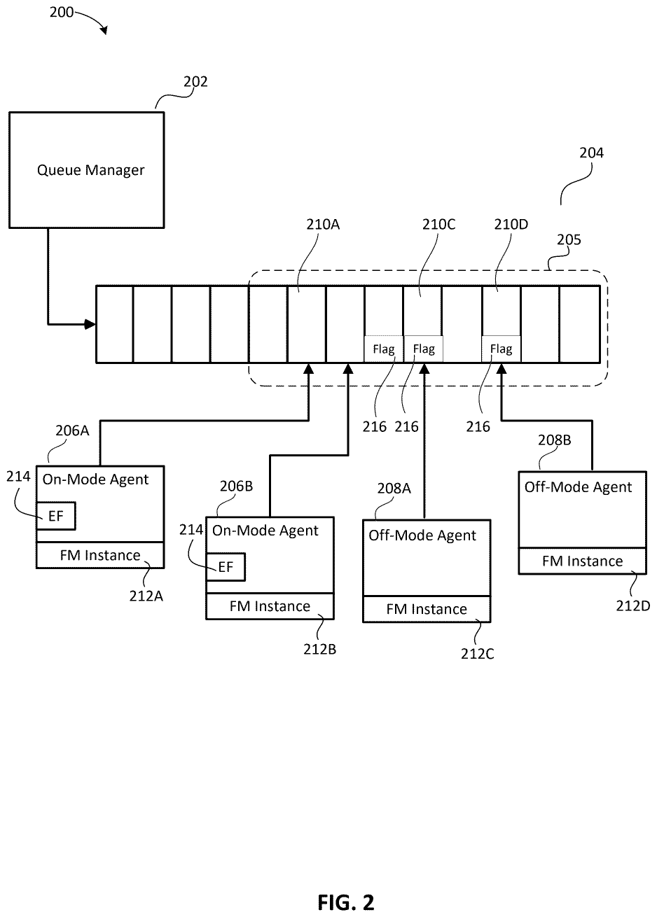

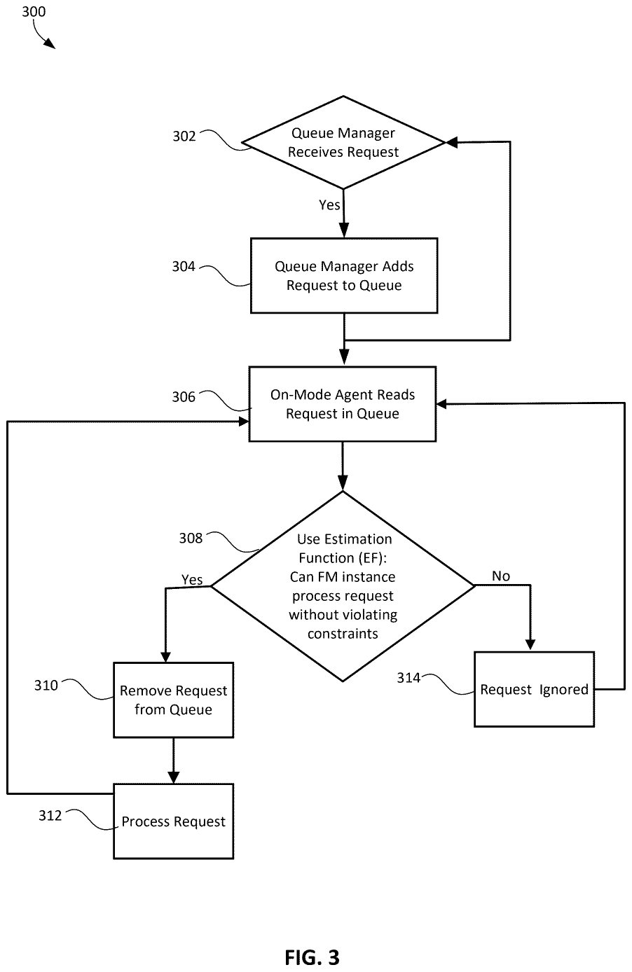

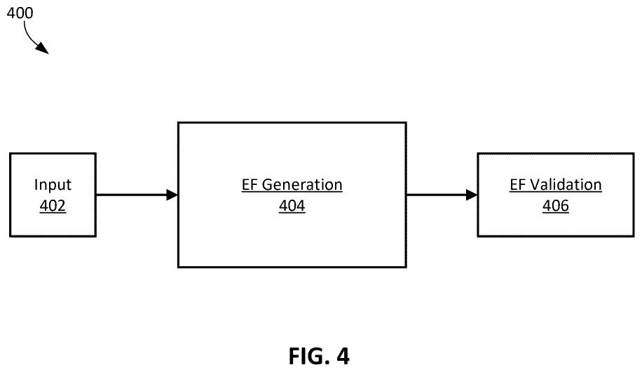

FIG. 2 shows a simplified block diagram of an exemplary continuous batching framework 200 according to an embodiment of the invention. Continuous batching framework 200 incudes queue manger 202, centralized queue 204, including request window 205, at least one on-mode agent 206, at least one off-mode agent 208, and foundation model (FM) instances 212. Each on-mode agent 206 and off-mode agent 208 is associated with a FM instance 212. FM instances 212 serve as executing instances of a foundation model. In the present example, on-mode agents 206A and 206B are associated with FM instances 212A and 212B respectively, and off-mode agents 208A and 208B are associated with FM instances 212C and 212D respectively, as shown in FIG. 2. On-mode agent 206 maintains a list of active requests (i.e., requests currently being processed by associated FM instance 212). Both on-mode agents 206 and off-mode agents 208 read requests 210 located within request window 205 of centralized queue 204. On-mode agent 206 further includes estimation function 214. On-mode agent 206 employs estimation function 214 for determining whether adding a new request will satisfy the processing requirements of the new request and all active requests. In the present example, on-mode agent 206A uses estimation function 214 for determining whether processing a new request will satisfy the processing requirements of the new request and all active requests being processed by associated FM instance 212A. Estimation function 214 is discussed in further detail below in reference to FIGS. 3 and 4.

FIG. 3 illustrates a simplified flow diagram of an exemplary method 300 of processing requests for large language model (LLM) generation. The method 300 may be implemented on one or more computer systems, such as, computer system 100. The method 300 may be carried out by one or more processors based on processor-executable instructions stored in memory within the one or more computer systems. For example, method 300 may be carried out by processor 102 based on processor-executable instructions stored in memory 104 of computer system 100.

Method 300 begins at block 302, wherein method 300 includes queue manager 202 receiving a new request. A request may include parameters indicating processing requirements to be met by the foundation model when the request is processed thereby. For instance, a request may specify a maximum number of tokens, e.g., 2000 tokens, that can be output by the foundation model during processing of the request. Alternatively, the maximum request of tokens that can be output by the foundation model during processing of the request provided in the request may be replaced by a default value provided by the continuous batching framework 200. In yet another instance, a request may specify an expected deadline, a time by which request processing is to be complete. Non conformance to these parameters will violate processing requirements of the request. In some instances, an expected deadline is not provided by a user, instead, it is a default value set by the service provider and added to the request thereby. Processing requirements are often derived from service level agreements between the customer/user and the service provider.

Upon receiving a new request, method 300 proceeds to block 304 wherein queue manager 202 adds the request to centralized queue 204. In the present example, centralized queue 204 includes a plurality of requests 210, as shown in FIG. 2. Method 300 returns to block 302 waiting for a new request.

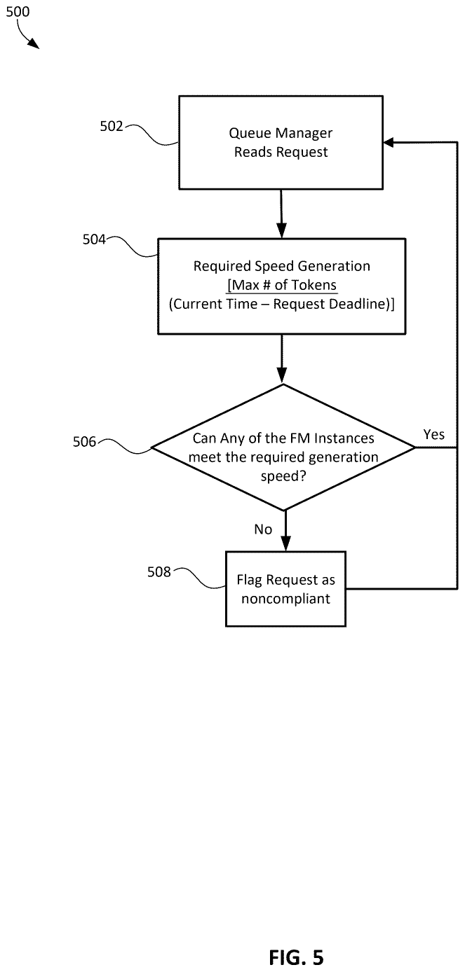

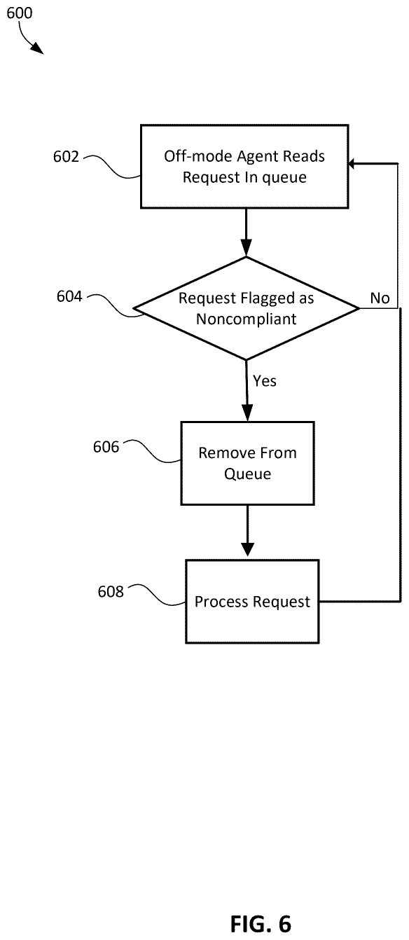

Next, at block 306, method 300 includes on-mode agent 206 reads a new request 210 from centralized queue 204 for evaluation. For example, on-mode agent 206A reads request 210A from centralized queue 204 for evaluation. In some instances, at block 306, method 300 further includes determining whether new request 210 has a noncompliant flag. If so, method 300 ignores request 210 and returns to block 302. Noncompliant flags are described in further detail below in reference to FIGS. 5 and 6.

At block 308, method 300 includes evaluating whether processing a new request by associated FM instance 212 would violate processing requirements of the new request or any one of the active requests, (i.e., requests currently being processed by associated FM instance 212). On-mode agents 206 maintains a list of active requests of the associated FM instance 212. If processing a new request 210 by FM instance 212 does not violate processing requirements of request 210 or the processing requirements of any active requests, method 300 proceeds to block 310, otherwise, method 300 proceeds to block 314 wherein the new request is ignored.

In the present example, FM instance 212A is currently processing a plurality of requests that on-mode agent 206A previously pulled/taken from centralized queue 204. Estimation function 214 of on-mode agent 206A evaluates whether processing request 210A by FM instance 212A would violate processing requirements of request 210A or any one of the active requests. In this example, estimation function 214 determines that processing requirements of the request 210A or any of the active requests would not be violated if FM instance 212A processes request 210A. As such, method 300 proceeds to block 310. Otherwise, method 300 proceeds to block 314 wherein the new request is ignored by on-mode agent 206A. In other words, on-mode agent 206A decided not to process the request 210A. Next method 300 returns to block 306.

At block 310, method 300 includes removing request 210 from centralized queue 204. For example, request 210A is removed from centralized queue 204.

Finally, at block 312, method 300 includes processing request 210A by FM instance 212. For example, request 210A is added to the batch of requests currently being processed by FM instance 212A. Next method 300 returns to block 306.

Referring now to FIG. 4, shown is a simplified flowchart of a method 400 of generating an estimation function prior to runtime.

Starting at block 402, method 400 includes providing input variables for training an estimation function. Specific and non limiting examples of input variables include, batch sizes, graphic processing unit (GPU) types, foundation model type and token input lengths.

Next, at block 404, method 400 comprises performing benchmark tests to evaluate the foundation model's performance under various levels of concurrency. In particular, method 400 includes utilizing the input variables for performing benchmark tests and outputting benchmark data indicating the speed generation of the model under different workload conditions. Next, method 400 includes generating an estimation function, such as estimation function 214, based on the benchmark data.

Finally, at block 406, method 400 includes validating the estimation function for deployment into the on-mode agent's decision-making process, enabling the on-mode agent to evaluate whether adding new requests will comply with processing requirements. (e.g., SLA guarantees).

According to an embodiment of the invention, a queue manager determines whether processing a request by any one of the FM instances associated with on-mode agents in a continuous batching framework exceeds the capacity of the FM instances. In such cases, the queue manager flags the request, for example, with a ‘non-compliant’ flag. In other words, the queue manager determines whether a required generation speed for processing a request exceeds a maximum processing capability of any instances of the foundation model associated with on-mode agents, and if so, flagging the request as noncompliant. Requests including ‘non-compliant’ flags are ignored by on-mode agents. A ‘non-compliant’ request that cannot be processed by any of the active on-mode agents within the constraints of its processing requirements is then left to be processed by an FM instance associated with one of the off-mode agents. That is, the off-mode agents may, among other things, select out requests from the queue that are flagged as non-compliant for processing by their associated FM instances. In this manner, the requests are still processed despite not being able to satisfy the processing requirements (e.g., SLA constraints), but they do not impact the processing of other requests within their respective processing requirements (e.g., SLA constraints).

Illustrated in FIG. 5 is a simplified flowchart of an exemplary method 500 of evaluating whether processing a request by any one of the FM instances associated with on-mode agents exceeds the capacity of any one of the FM instances.

Method 500 begins at block 502 wherein method 500 includes reading, by a queue manager, a request from a centralized queue. For example, queue manager 202 reads request 210C for evaluation.

As described above, a request specifies processing requirements in the form of a maximum number of tokens (max_new_tokens) that can be output by the foundation model during processing of the request and/or a time by which processing the request is to be complete (expected deadline). Other processing requirements may be included in other implementations. At block 504, method 500 includes determining, by the queue manager, the required generation speed of the foundation model to meet processing requirements of the request. In this example, the queue manager first determines the remaining time left for completion of processing the request by subtracting the current time from the expected deadline. Next, the queue manager determines the expected generation speed by dividing the max_new_tokens by the remaining time.

For example, request 210C specifies a maximum number of tokens, 1000 tokens, and an expected deadline, 10:22:32. In this example, the current time is 10:20:10. Queue manager 202 determines the remaining time left for completion of processing the request by subtracting 10:20:10 from 10:22:32, which is 2 mins 22 seconds or 142 seconds. Next queue manager 202 determines the expected generation speed by dividing the max_new_tokens, 1000, by the remaining time, 142 seconds, which is 7.04 tokens/sec. In some examples, the request may specify its processing requirement in terms of a maximum duration within which a response is needed, e.g. 3 seconds. The queue manager may, on receiving the request, determine the request deadline and associate that deadline with the request. Based on the current time and the request deadline, the queue manager is able to determine the amount of time remaining before a response must be provided in order to satisfy the processing requirement for that request.

Next, at block 506, method 300 includes determining whether the expected speed generation exceeds the capacity of the FM instances. In other words, method 300 includes determining whether a required generation speed for processing the request exceeds the maximum processing capability of any instances of the foundation model associated with on-mode agents, In the present example, the expected generation speed 7.04 tokens/sec exceeds the current capacity of both FM instances 212A and 212B and method 500 proceeds to block 508. However, should the expected generation speed not exceed the capacity of either FM instances 212A or 212B, method 500 returns to block 502.

Finally, at block 508, the queue manager flags the request as noncompliant. For example, queue manager 202 flags request 210C with noncompliant flag 216, as shown in FIG. 2. Next, method 500 returns to block 502.

Now referring to FIG. 6, illustrates a simplified flowchart of another exemplary method of processing requests for large language model (LLM) generation.

Method 600 begins at block 602 wherein method 600 includes reading a request from a centralized queue by an off-mode agent. For example, off-mode agent 208B reads request 210D.

Next at block 604, method 600 includes determining whether the read request has been flagged as noncompliant. If the request has not been flagged as noncompliant, method 600 returns to block 602. However, if the request has been flagged as noncompliant, method 600 proceeds to block 606. In the present example, off-mode agent 208B evaluates request 310D and determines that it has been flagged with a non-compliant flag. Method 600 proceeds to block 606.

At block 606, the off-mode agent removes the request flagged as noncompliant from the centralized queue. For example, off-mode agent 208D removes request 210D from centralized queue 204.

Finally, at block 608, the FM instance associated with the off-mode agent processes the request. For example, FM instance 212D associated with off-mode agent 208D processes request 210D. Next, method 600 returns to block 602.

In some instances, a continuous batching framework is operating in an environment wherein processing resources are distributed, for example, in a hybrid cloud environment. In such an environment, requests are distributed by a queue manager for processing by local resources or transmitted to a remote system for processing (e.g., cloud processing). The queue manager distributes requests dynamically based local system load and resource availability.

The systems and methods described herein relate to a process requirement aware (e.g., SLA aware) continuous batching framework aimed at ensuring high-priority tasks meet processing requirements. A continuous batching framework identifies requests whose processing requirements cannot be satisfied by the framework and prioritizes allocation of resources to those requests whose processing requirements can be met. This feature in combination with on-mode agents that individually assess the impact of processing a new request on active requests currently being processed by an associated FM instance further aides in meeting processing requirements of requests as they are continuously added to the queue.

In the present disclosure, the terms “a”, “an” and “one” are defined to mean “at least one”, that is, these terms do not exclude a plural number of items, unless stated otherwise.

In the present disclosure, terms such as “substantially”, “generally” and “about”, which modify a value, condition or characteristic of a feature of an embodiment, should be understood to mean that the value, condition or characteristic is defined within tolerances that are acceptable for the proper operation of this embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in embodiments of this application. “At least one” means one or more, and “a plurality of” means two or more. The term “and/or” describes an association relationship of associated objects and indicates that three relationships may exist. For example, A and/or B may indicate the following three cases: Only A exists, both A and B exist, and only B exists, where A and B may be singular or plural. The character “/” usually indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes A, B, C, A and B, A and C, B and C, or A, B, and C, and “at least one of A, B, and C” may also be understood as including A, B, C, A and B, A and C, B and C, or A, B, and C. In addition, unless otherwise specified, ordinal numbers such as “first” and “second” in embodiments of this application are used to distinguish between a plurality of objects, and are not used to limit a sequence, a time sequence, priorities, or importance of the plurality of objects.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements. The term “and/or” is intended to indicate that either of the two elements may be included or both of the elements may be included.

A person skilled in the art will understand that embodiments of this application may be provided as a method, an apparatus (or system), a computer-readable storage medium, or a computer program product. Therefore, this application may use a form of a hardware-only embodiment, a software-only embodiment, or an embodiment with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

It will be understood that a person skilled in the art may make various modifications and variations to this application without departing from the scope of this application. This application is intended to cover these modifications and variations of this application provided that they fall within the scope of protection defined by the following claims and their equivalent technologies.

Throughout the present disclosure, a processor, a processor system, an application processor, a baseband processor, a processor circuit, or a processor core may be collectively referred to as a processor. A processor may include one or more of a central processing unit (CPU), a digital signal processor (DSP), a microprocessor unit (MPU), a microcontroller unit, (MCU), a graphics processing unit (GPU), a field programmable gate array (FPGA), an artificial intelligence (AI) processor, or a neural network processing unit (NPU), or a combination of at least two of these integrated circuit forms.

Throughout the present disclosure, a memory may include one or more of the following storage media: a RAM, a static random access memory (SRAM), a dynamic random access memory (DRAM), a phase-change memory (PCM), a resistive random access memory (ReRAM), a magnetoresistive random access memory (MRAM), a ferroelectric random access memory (FRAM), a cache, a register, a read-only memory (ROM), a flash memory, an erasable programmable read-only memory (EPROM), a hard disk, and/or the like. In an example, the computer program instructions used to execute embodiments contained herein may be stored in a non-volatile memory. When a terminal runs, part or all of corresponding computer program instructions may be loaded into a memory that has a higher transmission speed with a corresponding processor, for example, the instructions may be loaded into at least a part of a memory such that the processor executes the computer program instructions to perform the steps in of embodiments described herein.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

What is claimed is:

1. A computer-implemented method comprising:
receiving a plurality of requests, each request including a prompt for processing by a foundation model and an indication of one or more processing requirements associated with the request;
using an estimation function, by a first on-mode agent of a plurality of on-mode agents, to determine that a first request of the plurality of requests in a queue can be processed by a first instance of the foundation model within constraints of the one or more processing requirements associated with the first request and without violating the one or more processing requirements associated with any of a plurality of requests currently being processed by the first instance of the foundation model, wherein each of the on-mode agents is associated with a respective instance of the foundation model; and
in response to the determination using the estimation function, processing the first request by the first instance of the foundation model.

2. The method according to claim 1 further comprising training the estimation function including performing tests evaluating the performance of the foundation model when processing a various number of requests concurrently, wherein input variables to the tests include at least of one batch size, GPU type, a foundation model type, and input length, for estimating generation speeds of the foundation model under different workload conditions.

3. The method according to claim 2, further comprising,
storing each of the plurality of requests in the queue and removing the first request from the queue.

4. The method according to claim 3, further comprising,
determining, by a queue manager, whether a required generation speed for processing a second request of the plurality of requests exceeds a maximum processing capability of any respective instances of the foundation model associated with the on-mode agents, and if so, flagging the second request as noncompliant.

5. The method according to claim 4, further comprising,
based on the second request being flagged as noncompliant, processing the second request by a foundation model instance associated with an off-mode agent and removing the second request from the queue.

6. The method according to claim 5, wherein the foundation model instance associated with the off-mode agent is implemented on a remote server and wherein the method further comprises transmitting the second request by the queue manager to the remote server for processing by the foundation model instance associated with the off-mode agent.

7. The method according to claim 4, wherein the second request includes an indication of a maximum number of tokens expected to be generated by the foundation model and an indication of a request deadline indicating a desired completion time of processing the second request by the foundation model.

8. The method according to claim 7, wherein determining a required generation includes determining a ratio of a maximum number of tokens expected to be generated by the foundation model and, a time difference between the request deadline and a current time.

9. The method according to claim 4, further comprising,
dependent on current processing capacity of a plurality of foundation model instances, identifying, by the queue manager, a third request of the plurality of requests as a low-priority request, and
transmitting by the queue manager, the third request to a remote server via a communication network for processing by a foundation model instance associated with a remote agent.

10. A computing system, comprising:
one or more processors; and
a memory storing computer-executable instructions that, when executed by the one or more processors, are to cause the one or more processors to:
receive a plurality of requests, each request including a prompt for processing by a foundation model and an indication of one or more processing requirements associated with the request;
use an estimation function, by a first on-mode agent of a plurality of on-mode agents, to determine that a first request of the plurality of requests in a queue can be processed by a first instance of the foundation model within constraints of the one or more processing requirements associated with the first request and without violating the one or more processing requirements associated with any of a plurality of requests currently being processed by the first instance of the foundation model, wherein each of the on-mode agents is associated with a respective instance of the foundation model; and
in response to the determination using the estimation function, process the first request by the first instance of the foundation model.

11. The computing system according to claim 10, wherein the instructions, when executed are to further cause the one or more processors to comprise, training the estimation function including performing tests evaluating the performance of the foundation model when processing a various number of requests concurrently, wherein input variables to the tests include at least of one batch size, GPU type, a foundation model type, and input length, for estimating generation speeds of the foundation model under different workload conditions.

12. The computing system according to claim 11, wherein the instructions, when executed are to further cause the one or more processors to comprise,
storing each of the plurality of requests in the queue and removing the first request from the queue.

13. The computing system according to claim 12, wherein the instructions, when executed are to further cause the one or more processors to comprise,
determining, by a queue manager, whether a required generation speed for processing a second request of the plurality of requests exceeds a maximum processing capability of any respective instances of the foundation model associated with the on-mode agents, and if so, flagging the second request as noncompliant.

14. The computing system according to claim 13, wherein the instructions, when executed are to further cause the one or more processors to comprise, based on the second request being flagged as noncompliant, processing the second request by a foundation model instance associated with an off-mode agent and removing the second request from the queue.

15. The computing system according to claim 14, wherein the foundation model instance associated with the off-mode agent is implemented on a remote server and, wherein the instructions, when executed are to further cause the one or more processors to comprise, transmitting the second request by the queue manager to the remote server for processing by the foundation model instance associated with the off-mode agent.

16. The computing system according to claim 13, wherein the second request includes an indication of a maximum number of tokens expected to be generated by the foundation model and an indication of a request deadline indicating a desired completion time of processing the second request by the foundation model.

17. The computing system according to claim 16, wherein determining a required generation includes determining a ratio of a maximum number of tokens expected to be generated by the foundation model and, a time difference between the request deadline and a current time.

18. The computing system according to claim 13, wherein the instructions, when executed are to further cause the one or more processors to comprise,
dependent on current processing capacity of a plurality of foundation model instances, identifying, by the queue manager, a third request of the plurality of requests as a low-priority request, and
transmitting by the queue manager, the third request to a remote server via a communication network for processing by a foundation model instance associated with a remote agent.

19. A non-transitory, computer-readable medium storing computer-executable instructions
that, when executed by one or more processors, are to cause the one or more processors to:
receive a plurality of requests, each request including a prompt for processing by a foundation model and an indication of one or more processing requirements associated with the request;
use an estimation function, by a first on-mode agent of a plurality of on-mode agents, to determine that a first request of the plurality of requests in a queue can be processed by a first instance of the foundation model within constraints of the one or more processing requirements associated with the first request and without violating the one or more processing requirements associated with any of a plurality of requests currently being processed by the first instance of the foundation model, wherein each of the on-mode agents is associated with a respective instance of the foundation model; and
in response to the determination using the estimation function, process the first request by the first instance of the foundation model.

20. The non-transitory, computer-readable medium according to claim 19 wherein the instructions, when executed are to further cause the one or more processors to comprise,
storing each of the plurality of requests in the queue and removing the first request from the queue; and
determining, by a queue manager, whether a required generation speed for processing a second request of the plurality of requests exceeds a maximum processing capability of any respective instances of the foundation model associated with the on-mode agents, and if so, flagging the second request as noncompliant.
